(19) United States
(12) Patent Application Publication
(10) Pub. No.: US 2019/0254319 A1
(43) Pub. Date: Aug. 22, 2019

(54) INSTANT RICE AND METHOD OF PRODUCING INSTANT RICE

(71) Applicant: NAGATANIEN HOLDINGS CO., LTD., Tokyo (JP)

(72) Inventor: Michimasa Kumagai, Tokyo (JP)

(21) Appl. No.: 16/277,711

(22) Filed: Feb. 15, 2019

(30) Foreign Application Priority Data
Feb. 20, 2018 (JP) 2018-028184

(51) Int. Cl. A23L 7/196; A23L 5/10; A23L 5/30

(52) U.S. Cl. CPC A23L 7/196; A23L 11/20; A23L 5/34; A23L 5/15

(57) ABSTRACT

The instant rice according to the embodiment of the present invention is dehydrated alpharized rice. The instant rice has an average major axis length of from 160% to 180% of an average major axis length of raw rice of the instant rice.

### CROSS-REFERENCE TO RELATED APPLICATIONS

This application is based upon and claims the benefit of priority from Japanese Patent Application No. 2018-028184, filed Feb. 20, 2018, the entire contents of which are incorporated herein by reference.

### FIELD

The present invention relates to instant rice and a method of producing instant rice.

### BACKGROUND

Recently, the need for foods that take less time to prepare and are easy to eat has increased. The research and development of such foods have progressed, and a number of such foods are commercially available. As for rice, products capable of taking less time to cook for meals have been developed. Among them, alpharized rice or swelled rice (puffed rice), which is dehydrated rice having excellent convenience and is rehydrated by hot water, is widely used, for example, as a general food on the market, as preserved foods for disasters, and as portable rations for mountain-climbing because of their excellent shelf-life, lightweight and non-bulky characteristics.

In Japan, where rice is the chief staple of the diet, the requirements for the flavor, etc. are very high. In other countries as well, the requirements for the flavor, etc. are growing more and more.

Conventionally, various producing methods have been developed to obtain dehydrated rice that is satisfactory as an instant food not only from the viewpoint of texture or flavor after rehydration, but also from the rehydration time.

For example, Jpn. Pat. Appln. KOKOKU Publication No. 34-5730 discloses the method of obtaining dehydrated rice by steaming raw white rice, that has been washed and has absorbed water, to evenly gelatinize its surface, immersing the rice in an enriched liquid containing vitamins and the like to make it sufficiently absorb water, steaming the rice to completely alpharize it, and then drying the rice by hot air to thereby obtain dehydrated rice.

In this literature, the primary condition to produce dehydrated rice that can quickly be rehydrated is to make rice sufficiently absorb water to preferably have a water content of 40% or more before heating and alpharizing it. For this reason, raw rice that has absorbed water is briefly steamed to alpharize its surface, thus improving the raw rice in water absorbency. After the water content is increased to 45% to 50%, the rice is completely alpharized.

Jpn. Pat. Appln. KOKAI Publication No. 62-181746 discloses the method of producing dehydrated alpharized rice by immersing polished white rice, that has been immersed in water at 30° C. or lower (hereinafter, “immersed in water”), in hot water at 50 to 70° C. (hereinafter, “immersed in hot water”), and then steaming and drying it. In this literature, the polished white rice is immersed in hot water between the water immersion process and the steaming process. This can increase alpharization even if the steaming process is performed for a short period of time, and can also prevent a reduction in the yield due to stickiness, etc.

Jpn. Pat. Appln. KOKAI Publication No. 56-151472 discloses the method of producing instant rice, in which the alpharized rice having a water content of from 50% to 65% after alpharization is (i) immersed in water to control the water content so that the water content of the alpharized rice increases by 10% or more, and then held for 30 min or more within the water content range of from 50% to 85%, or (ii) controlling the water content by water or the like for 30 min or more so that the water content of the alpharized rice increases by 10% or more, and then is dried by hot air or the like, not by freeze-drying.

The purpose of performing the water-content control is to allow rice grain tissues to swell. The purpose of holding it for 30 min or more, performed thereafter or in parallel therewith, is to disperse the water that is mainly distributed on the rice grain surface to the center portion so that instant rice having a porous structure can be obtained by a drying process subsequently performed.

### SUMMARY

The dehydrated rice described in Jpn. Pat. Appln. KOKOKU Publication No. 34-5730 is rehydrated in 50 min by water or in 25 min by hot water. The quick cooking property is still insufficient.

The invention disclosed in Jpn. Pat. Appln. KOKAI Publication No. 62-181746 relates to the method of producing the dehydrated alpharized rice that is excellent in rehydration properties when heated by a microwave oven, etc. The invention is not directed to a dehydrated alpharized rice production method that assumes hot water rehydration focusing on quick cooking properties. That is, the dehydrated alpharized rice obtained by the method disclosed in this literature requires heat rehydration by a microwave oven, and is not rehydrated by pouring hot water.

Furthermore, according to the method described in the literature, the raw rice is set to have a water content of from about 40% to about 65% by hot water immersion (water content essentially equal to that of normal cooked rice), and it is steamed and dried to thereby obtain dehydrated alpharized rice. The hot water immersion time is long, and is preferably 3 hours or less, and more preferably about 30 min to 1 hour and half. Thus, there is still the problem in terms of workability.

Jpn. Pat. Appln. KOKAI Publication No. 56-151472 describes that the alpharized rice with a water content of from 50% to 65% is obtained by adding water to water-absorbed raw rice and performing an alpharization process on the rice at one time using a rice cooker, a steamer, or the like. However, if water-content control is performed for the rice alpharized in such a manner so that the water content increases by 10% by immersion or the like, it is likely that starch is eluted from the rice grains at the time of immersion and that the rice grains deform or agglomerate. In particular, if the water content is controlled to be 65% or more which is considered excellent in the working examples and then the rice is held for 30 min or more, the rice grains significantly adhere to each other and deform and the water content is high, resulting in problems of drying efficiency in the subsequent steps and energy costs.

As described above, currently there is no dehydrated alpharized rice that is satisfactory as instant rice in terms of the rehydration time by hot water and the texture, flavor, and outer appearance after rehydration. In addition, there are problems of workability and drying efficiency in the production.

That is, according to the conventional method of producing instant rice of dehydrated alpharized rice, it was difficult to simultaneously implement satisfactory rehydration properties and workability in the production.

It is therefore an object of the present invention to provide instant rice of dehydrated alpharized rice which is rehydrated in a short time and exhibits excellent flavor, texture, and outer appearance after rehydration, and to provide an efficient production method thereof.

The present invention includes the following aspects to solve the aforementioned problems.

According to the first aspect of the present invention, there is provided instant rice, which is dehydrated alpharized rice, the instant rice having an average major axis length of from 160% to 180% of an average major axis length of raw rice of the instant rice.

According to the second aspect of the present invention, there is provided a method of producing instant rice, the instant rice being dehydrated alpharized rice, the method including: (a) obtaining water-absorbed rice, including boiling raw rice in hot water at a rice starch alpharization temperature or higher; (b) obtaining steamed rice, including steaming the water-absorbed rice; and (c) drying the steamed rice.

According to another aspect of the present invention, the instant rice has an average major axis length of from 160% to 180% of an average major axis length of the raw rice.

According to another aspect of the present invention, the obtaining (a) further includes performing water cooling after boiling.

According to another aspect of the present invention, the obtaining (a) further includes equalizing water contained in the water-absorbed rice after boiling or after water cooling if the obtaining (a) includes performing water cooling after boiling.

According to another aspect of the present invention, the obtaining (a) further includes draining water of the water-absorbed rice last.

According to another aspect of the present invention, the hot water at the rice starch alpharization temperature or higher used in the obtaining (a) is 90° C. or higher.

According to another aspect of the present invention, the water-absorbed rice obtained in the obtaining (a) is in a state in which starch on rice grain surface is alpharized and at least part of starch contained inside the rice grain is not alpharized.

According to another aspect of the present invention, the water-absorbed rice obtained in the obtaining (a) has a mass within a range of from 210% to 260% with respect to a mass of the raw rice.

According to another aspect of the present invention, the steamed rice obtained in the obtaining (b) has a mass within a range of from 210% to 270% with respect to a mass of the raw rice.

According to another aspect of the present invention, the obtaining (a) further includes immersing the raw rice in water before the obtaining (a).

According to the present invention, it is possible to provide instant rice which is dehydrated alpharized rice, in which the rice is rehydrated in a short time and is excellent in flavor, texture, and outer appearance after rehydration. Moreover, such instant rice can be produced in an efficient manner.

Thus, the instant rice according to the present invention can widely be used not only as an instant food for convenience, but also as a preserved food for disasters.

### BRIEF DESCRIPTION OF THE DRAWING

FIG. 1 is a graph showing changes in an average major axis length of instant rice by a difference in boiling times, and changes in an extension rate of the average major axis length of the instant rice by the difference in boiling times.

### DETAILED DESCRIPTION

The present embodiment will be described below.

A method of producing instant rice according to the present embodiment includes: step (a) obtaining water-absorbed rice, including boiling raw rice in hot water at a rice starch alpharization temperature or higher; step (b) obtaining steamed rice, including steaming the water-absorbed rice; and step (c) drying the steamed rice.

The “instant rice” means dehydrated alpharized rice. The “dehydrated alpharized rice” is rice obtained by hydrating and heating the raw rice to alpharize the starch followed by drying, and is clearly distinguished from swelled rice (puffed rice) obtained by alpharizing the starch contained in the raw rice followed by drying at a high temperature to swell tissues.

The raw rice of the instant rice used in the instant rice production method according to the present embodiment is not particularly limited, and may be of a short grain rice variety or a medium grain rice variety. Examples include ordinary short-grain uruchi rice and medium-grain polished white rice of California rice. The raw rice may also be rice to which a wash-free process has been applied. Brands thereof are not particularly limited.

In the instant rice production method according to the present embodiment, first, the raw rice is washed as needed. After that, the raw rice is preferably immersed in water at a normal temperature (e.g., 10° C. to 30° C.) (referred to as “immersion at the normal temperature” as well) to bring the raw rice to absorb water. The immersion time is not particularly limited, and 30 min to 2 hours is preferable, for example.

The water content of the raw rice after immersion at the normal temperature is preferably 26 to 35 mass %, more preferably 28 to 33 mass %. It is noted that the water content of the raw rice does not normally become 40 mass % or more unless the raw rice is immersed in hot water at the rice starch alpharization temperature or higher, and the water content of the raw rice after immersion at the normal temperature does not become 40 mass % or more. In the following description, the raw rice after immersion at the normal temperature may be referred to as “low water-absorbed rice” in comparison to “high water-absorbed rice” obtained by later-described step (a).

The instant rice production method according to the present embodiment includes step (a) including boiling the raw rice in hot water at the rice starch alpharization temperature or higher. The water-absorbed rice obtained by step (a) is water-absorbed rice in a semi-cooked state, and preferably has a predetermined mass ratio with respect to the raw rice described below and/or a predetermined water content described below. The semi-cooked state is a state in which the starch on the rice grain surface is alpharized while at least part of the starch contained inside the rice grains is not alpharized.

The water-absorbed rice of the semi-cooked state as described above may be obtained by adjusting the temperature of the hot water used for boiling (hereinafter, “boiling temperature”) and/or the boiling time, or applying water cooling to the water-absorbed rice after boiling.

In the following description, the water-absorbed rice obtained by step (a) may also be referred to as “high water-absorbed rice” to distinguish it from the low water-absorbed rice obtained by immersion at the normal temperature described above. It is noted that if step (a) further includes performing water cooling after boiling, the high water-absorbed rice means water-absorbed rice obtained after water cooling.

In the present embodiment, the mass of the high water-absorbed rice is preferably within a range of from 210% to 260% with respect to the mass of the raw rice, more preferably within a range of from 220% to 250%.

If the mass ratio of the high water-absorbed rice with respect to the raw rice is 210% or more, alpharization of the starch in the steaming process in subsequent step (b) progresses, and the rice grains extend in a major axis direction, which improves rehydration properties as instant rice and is preferred. If the mass ratio of the high water-absorbed rice with respect to the raw rice is 260% or less, it is possible to suppress elution of the starch, prevent deformation of the outer appearance of the rice grains or agglomeration, and provide a texture of graininess. Moreover, stickiness is suppressed and a non-clumping state is provided, which is preferred in terms of workability.

For similar reasons, the water content of the high water-absorbed rice is preferably within a range of from 59 to 67 mass %, more preferably within a range of from 61 to 66 mass %.

The high water-absorbed rice having the aforementioned characteristics may be obtained by, as described above, appropriately adjusting the boiling temperature and/or the boiling time, preferably by applying water cooling to the water-absorbed rice after boiling.

The preferable boiling temperature and boiling time are appropriately adjusted in accordance with brands of the raw rice used, production locations, production year, the amount processed, and the like. The boiling temperature may be the rice starch alpharization temperature or higher, and in an aspect, the temperature is preferably 90° C. or higher, more preferably 90° C. or higher and 100° C. or lower. The boiling time is, in one aspect, preferably 2 min to 12 min, more preferably 6 min to 10 min.

In the boiling process, it is preferable to perform stirring by a mechanical water current to uniformly heat rice grains.

As described above, it is preferable that step (a) further includes performing water cooling after boiling. The boiling process alpharizes the surface layers of the rice grains, but water cooling after boiling stops the alpharization progress by residual heat. As a result, alpharization of the high water-absorbed rice does not proceed excessively, and excessive water absorption is suppressed, which results in a non-clumping state in which stickiness of the rice grain surfaces is suppressed. Thus, it is preferable to perform water cooling quickly after boiling.

The water cooling process is performed by, for example, using normal-temperature water or cooling water and subjecting the water-absorbed rice to the water for a time essentially equal to the boiling time. A specific temperature of water used for water cooling and specific water cooling time are adjusted in accordance with brands of the raw rice to be used, production locations, production year, the amount processed, and the like, in such a manner that the high water-absorbed rice has the aforementioned characteristics. In one embodiment, the temperature of water used for water cooling is preferably 5 to 65° C.

In the present embodiment, the high water-absorbed rice to which water cooling is applied after boiling is put through a mesh container such as a sieve to sufficiently drain water.

Since the instant rice production method according to the present embodiment includes step (a), it is possible to obtain the high water-absorbed rice in the semi-cooked state containing, in the rice grains, the water required for sufficient alpharization of the rice starch in a steaming process performed in subsequent step (b). In step (b), the high water-absorbed rice obtained in step (a) is steamed to obtain sufficiently alpharized steamed rice while stickiness is suppressed. Subsequent step (c) dries the steamed rice obtained in step (b), thereby efficiently obtaining instant rice that is rehydrated in a short time and exhibits excellent flavor, texture, and outer appearance after rehydration.

As described earlier, when the raw rice is immersed in water at a temperature less than the rice starch alpharization temperature, it is normally impossible to obtain water-absorbed rice having a water content exceeding 40 mass %. If such water-absorbed rice (e.g., the water-absorbed rice described above) is steamed, the starch of rice grains is not sufficiently alpharized. For this reason, if the low water-absorbed rice obtained after immersion at the normal temperature is steamed without undergoing step (a) including the boiling process and then the obtained steamed rice is dried, crystals of the starch remain. The rice has inferior rehydration properties as instant rice, particularly having a hard, inferior texture.

Sufficiently alpharized rice can be prepared by the ordinary rice cooking method in which the raw rice is washed and water is added thereto, or by sprinkling water onto the rice or bringing the rice in contact with water in the middle of cooking. However, if there is excessive water present outside the rice grains at the time of alpharization, the starch is eluted from the surfaces of the rice grains, resulting in occurrence of stickiness and poor workability.

It is preferable that step (a) further includes equalizing the water contained in the high water-absorbed rice after boiling or after water cooling if the step includes performing water cooling after boiling. The water contained in the high water-absorbed rice can be equalized by, for example, leaving the high water-absorbed rice for a predetermined period of time. That is, the water that is present more so on the surface layer of the high water-absorbed rice moves to the inside of the rice grains by leaving the high water-absorbed rice, and thus the water contained in the rice grains is equalized. Therefore, not only the inside of the rice grain is uniformly alpharized by the steaming process subsequently performed, but also elution of the starch of the surface layer is prevented as compared to when the water eccentrically exists, and stickiness can be suppressed.

Equalizing the water by leaving the rice can be performed by, for example, draining water of the high water-absorbed rice, and then leaving it in a container, etc. or leaving it while being placed in a steam container. The high water-absorbed rice is preferably left in a manner so that the surface layer thereof does not become dried, but the container does not necessarily have to be sealed as long as the surface layer of the high water-absorbed rice does not become dried.

The time and the temperature of leaving the high water-absorbed rice can be suitably set. For example, it is preferably left for about 30 min to 120 min at a normal temperature (e.g., 10° C. to 30° C.).

The instant rice production method according to the present embodiment includes step (b) including steaming the high water-absorbed rice obtained by step (a). By steaming process in step (b), steamed rice in which alpharization sufficiently progresses is obtained. The mass of the steamed rice obtained in step (b) is preferably within a range of from 210% to 270% with respect to the mass of the raw rice, more preferably within a range of from 220% to 250%. Furthermore, the water content of the steamed rice is preferably within a range of from 59 mass % to 67 mass %, more preferably within a range of from 61 mass % to 66 mass %.

The above-indicated values of the mass ratio of the steamed rice with respect to the raw rice and the water content ratio are essentially equal to those of normal cooked rice. In the production method according to the present embodiment, because no water exists outside the rice grains at the time of alpharization by the steaming process in step (b), stickiness is prevented, and workability and handling are facilitated.

In the present embodiment, the steaming process can be performed, for example, using a batch-type or continuous-type steamer at the atmospheric pressure at the temperature of 95° C. or higher.

The instant rice production method according to the present embodiment includes step (c), performed after step (b), of drying the steamed rice obtained by step (b).

Drying methods are not particularly limited. It may be performed by hot air drying using a belt-type circulation drier or a rack-type circulation drier, or may be performed using a reduced-pressure drier, etc.

In the present embodiment, drying is performed so that the alpharized rice has a water content of 8 mass % or less. The drying temperature is normally 70° C. or more, preferably a temperature at which rice grains do not swell, more preferably 70′C or more and 90° C. or less.

The instant rice obtained by the production method according to the present embodiment is not only rehydrated to the original cooked rice by pouring hot water and holding it in a short time (e.g., 5 min or so), but rehydrated to rice that is excellent in flavor, texture, and outer appearance. Furthermore, by only putting in a container the instant rice, water, seasoning liquid, ingredients, etc. and heating them over direct heat or by an oven for a few minutes, the instant rice was widely usable as normal rice, takikomi gohan (boiled rice with other ingredients), pilaf, gratin, etc.

Moreover, the further study on the rehydration properties of the instant rice indicated that the instant rice having remarkably excellent rehydration properties tends to have a long grain shape. Thus, as a result of further research regarding the relation between the shape of the instant rice and the rehydration properties, it was found that there is a correlation between the extension rate of the major axis length of the instant rice and the rehydration properties.

That is, it is preferable that the average extension rate of the major axis length of the instant rice according to the present embodiment is 160% or more with respect to the average major axis length of the raw rice (hereinafter referred to as “extension rate of the major axis length of the instant rice” or simply as “extension rate of the major axis length”). If the extension rate of the major axis length is 160% or more, the rehydration property increases remarkably. The reason thereof is not necessarily certain. The grains of the dehydrated alpharized rice are thinner and longer in the major axis direction with respect to the raw rice. Thus, as the extension rate of the major axis length of the instant rice increases, the surface area of the grain of the instant rice tends to be wider. This is assumed to contribute to the increase in the rehydration properties. The extension rate of the major axis length is preferably 180% or less. If the extension rate of the major axis length is 180% or less, it is possible to suppress elution of the starch, to prevent deformation of outer appearance of the rice grains or agglomeration, and to provide a texture of graininess. Moreover, stickiness is suppressed and a non-clumping state is provided, which is preferred in terms of workability. The extension rate of the major axis length of the instant rice with respect to the raw rice is more preferably from 160% to 170%.

The instant rice having the extension rate of the major axis length of the aforementioned range is preferably produced using the production method according to the present embodiment. For example, adjustments can be made by suitably setting various parameters such as the boiling time and the boiling temperature in the production method described above.

Here, the “major axis length” of the raw rice and the instant rice was a distance from the endmost point where the germ part is dropped and deficient to the farther point opposite to the endmost point, in the polished rice grain and the instant rice grain, respectively. In addition, the “average major axis length” of the raw rice and the instant rice was determined by randomly sampling 100 grains from each specimen and measuring 100 major axis lengths by calipers to obtain an average value thereof.

In general, it is somewhat difficult to measure the dehydrated alpharized rice because the rice grains tend to adhere to each other and the grains are deformed or broken, but there are many grains maintaining the shape close to the original rice grain shape. By sampling such rice gains, major axis lengths can be measured.

The instant rice according to the present embodiment is thinner as compared to the raw rice while extending in the major axis direction, but the rice grains are prevented from being deformed or broken. Measurements are comparatively easy.

### EXAMPLES

<Raw Rice>

In each example described below, the polished rice of the short grain rice variety or the medium grain rice variety shown in Table 1 was used as the raw rice.

The average major axis length shown in the table was determined by randomly sampling 100 grains from the raw rice as each sample and measuring 100 major axis lengths by calipers to obtain an average value thereof.

TABLE 1

| Raw rice | Average major axis | Standard error | Production |
|---|---|---|---|
| (Polished rice) | length (mm) | SE (mm) | location |
| Wash-free rice | 4.74 | 0.03 | Miyagi |
| Hitomebore | | | Prefecture |
| Hitomebore | 4.65 | 0.02 | Miyagi |
| | | | Prefecture |
| Koshihikari | 4.66 | 0.02 | Niigata |
| | | | Prefecture |
| Akitakomachi | 4.79 | 0.02 | Ibaraki |
| | | | Prefecture |
| Eminokizuna | 4.66 | 0.02 | Fukushima |
| | | | Prefecture |
| Nanatsuboshi | 4.59 | 0.02 | Hokkaido |
| California rice | 5.70 | 0.03 | U.S.A |

For the instant rice obtained using the production method according to the present embodiment, the relation between the extension rate of the major axis length and the rehydration property will be shown through Test Examples 1 and 2.

### Test Example 1

As the raw rice, eight of 250 g of wash-free rice Hitomebore were prepared. Each sample was immersed in water (temperature 20° C.) for approximately 1 hour. Next, for each sample, the eight-staged different boiling time was set from 3 to 12 min, and each sample was boiled for the set boiling time in hot water at 96° C. Immediately after boiling, the sample was immersed and cooled in water at 30° C. for the time equal to each boiling time, and then was drained to obtain high water-absorbed rice. The high water-absorbed rice was left for approximately 1 hour in the container in such a manner that the rice did not become dried, equalizing the water contained in each high water-absorbed rice. Next, each sample was placed on a wire net to be completely alpharized in a steam oven at 100° C. for 30 min. The obtained steamed rice (alpharized rice) was dried by forced-air drying at 80° C. to obtain instant rice of dehydrated alpharized rice.

The rehydration properties of the obtained instant rice were evaluated by the following method.

[Evaluation of Rehydration Properties]

30 g of the obtained instant rice was put in a paper cup, 150 g of hot water was poured in it, and the cup was covered by a lid and held for 5 min. The rehydration properties were evaluated visually and by eating. The rehydration properties were evaluated in terms of 5 min rehydration time, and in terms of taste, texture as well as outer appearance after rehydration.
Evaluation of 5 min rehydration time

A: Sufficiently rehydrated

B: Not sufficiently rehydrated, slightly hard, but edible

C: Not rehydrated, hard, and not edible
Evaluation of taste, texture, and outer appearance after rehydration

A: Good taste, excellent texture with rich softness and elasticity, smooth rice skin, and excellent outer appearance with no deformation of shape of rice grains or agglomeration

B: Any one of taste, texture and outer appearance inferior to Evaluation A

C: Any two of taste, texture and outer appearance inferior to Evaluation A

D: All of taste, texture and outer appearance inferior to Evaluation A

Table 2 shows the boiling time, the mass ratio of the high water-absorbed rice with respect to the raw rice, the mass ratio of the steamed rice with respect to the raw rice, the average major axis length of the instant rice, the extension rate of the major axis length of the instant rice, and the evaluation results of rehydration properties. The average major axis length of the instant rice was measured by the same method of measuring the average major axis length of the raw rice described above.

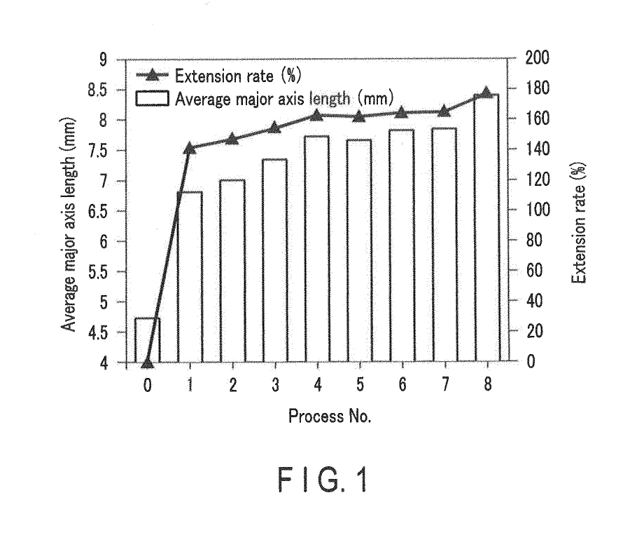

FIG. 1 is a graph showing the changes in the average major axis length of the instant rice by the difference in the boiling times, and the changes in the extension rate of the average major axis length of the instant rice by the difference in the boiling times.

TABLE 2

| | | Raw | | | | | | | | |
|---|---|---|---|---|---|---|---|---|---|---|
| | | rice | Ex. 1 | Ex. 2 | Ex. 3 | Ex. 4 | Ex. 5 | Ex. 6 | Ex. 7 | Ex. 8 |
| | | Process 0 | Process 1 | Process 2 | Process 3 | Process 4 | Process 5 | Process 6 | Process 7 | Process 8 |
| Boiling time (min) | | — | 3 | 4 | 5 | 6 | 7 | 8 | 10 | 12 |
| Mass ratio of high water-absorbed rice (%) | | — | 181 | 195 | 204 | 218 | 228 | 237 | 252 | 264 |
| Mass ratio of steamed rice (%) | | — | 186 | 197 | 208 | 222 | 233 | 240 | 259 | 271 |
| Average major axis length (mm) | | 4.74 | 6.8 | 7.03 | 7.36 | 7.74 | 7.68 | 7.84 | 7.86 | 8.42 |
| Standard error SE (mm) | | 0.03 | 0.05 | 0.06 | 0.06 | 0.06 | 0.08 | 0.08 | 0.09 | 0.09 |
| Extension rate (%) | | — | 143 | 148 | 155 | 163 | 162 | 165 | 166 | 181 |
| Rehydration | Evaluation of rehydration | — | C | C | B | A | A | A | A | A |
| property | time | | | | | | | | | |
| | Evaluation of taste, texture | — | — | — | B | A | A | A | A | C |
| | and outer appearance after | | | | | | | | | |
| | rehydration | | | | | | | | | |

According to the results, Example 4 to Example 7 showed the remarkably excellent rehydration properties among the instant rice obtained. In Example 4 to Example 7, the extension rate of the major axis length of the instant rice was within the range of from 160% or more and 180% or less. For wash-free rice Hitomebore used in the present test, as shown by Process 8, the rice grains having the high extension rate of over 180% were highly swollen, and it was shown that the flavor slightly degraded and that the workability degraded due to stickiness.

In Example 4 to Example 7 showing the remarkably excellent rehydration properties, the mass ratio of the high water-absorbed rice with respect to the raw rice was within the range of from 210 to 260%, and the mass ratio of the steamed rice with respect to the raw rice was within the range of from 210 to 270%.

### Test Example 2

For the five brands other than wash-free rice Hitomebore and Hitomebore in Table 1, the relation between the extension rate of the major axis length and the rehydration properties was studied in a manner similar to Test Example 1. Except that the boiling time was appropriately changed to vary the mass ratio of the high water-absorbed rice and to adjust the extension rate of the major axis length of the instant rice in the instant rice production method of Test Example 1, the similar method in Test Example 1 was used to produce the instant rice from each raw rice of the five brands including the medium grain rice variety. The relation between the extension rate of the major axis length and the rehydration properties of the instant rice obtained is shown in Table 3. The measurement method, the evaluation method, and the like were those used in Test Example 1.

TABLE 3

| | | | | | | | Rehydration property | |
|---|---|---|---|---|---|---|---|---|
| | | Mass ratio of | | | | Extension | | Evaluation of taste, |
| | | high water- | Mass ratio of | Average major | Standard | rate of | Evaluation of | texture and outer |
| | Raw rice | absorbed rice | steamed rice | axis length | error SE | major axis | rehydration | appearance after |
| | (Polished rice) | (%) | (%) | (mm) | (mm) | length (%) | time | rehydration |
| Ex. 101 | Koshihikari 1 | 211 | 211 | 7.53 | 0.66 | 161 | B | B |
| Ex. 102 | Koshihikari 2 | 235 | 239 | 8.45 | 0.08 | 180 | A | A |
| Ex. 103 | Akitakomachi 1 | 217 | 219 | 7.29 | 0.06 | 152 | C | — |
| Ex. 104 | Akitakomachi 2 | 236 | 238 | 7.82 | 0.06 | 163 | A | A |
| Ex. 105 | Nanatsuboshi | 234 | 237 | 8.03 | 0.07 | 174 | A | A |
| Ex. 106 | Eminokizuna | 232 | 238 | 8.16 | 0.07 | 175 | A | A |
| Ex. 107 | California rice 1 | 228 | 234 | 9.27 | 0.10 | 162 | A | A |
| Ex. 108 | California rice 2 | 217 | 221 | 8.64 | 0.07 | 151 | B | C |

The results show that the excellent rehydration properties were exhibited by the instant rice in which the extension rate of the major axis length was within the range of from 160% to 180% including California rice of the medium grain rice variety. The mass ratio of the high water-absorbed rice and the mass ratio of the steamed rice with respect to the raw rice were within the ranges from 210 to 260% and 210 to 270%, respectively. The results were nearly equal to those of Test Example 1.

The results show that the extension rate of the major axis length of the instant rice is highly involved in the rehydration property of the instant rice, and that the rehydration property increases if the extension rate of the major axis length is 160% or more. It is assumed that the reason thereof is that, as described above, the increase in the extension rate of the major axis length which increases the surface area of the instant rice contributes to the increases in the rehydration properties.

### Comparative Example 11

120 mass % of water at a mass ratio was added to wash-free rice Hitomebore to make it absorb water, and then the rice was cooked by an electronic rice cooker. Wash-free rice Hitomebore of the raw rice has an average major axis length of 4.74 mm (Table 1). The obtained cooked rice had an average major axis length of 7.7 mm. The extension rate of the major axis length was approximately 163%. After the rice was dried, however, the average major axis length of the dehydrated rice obtained shrank to approximately 6.6 mm, and the extension rate of the major axis length was approximately 140%.

The rehydration properties of the dehydrated rice obtained were evaluated by the similar method described above. The dehydrated rice 5 min after the hot water was poured was not rehydrated, was hard, and was not edible.

### Comparative Example 21

The cooked rice obtained in Comparative Example 1 was immersed in hot water for 1 hour to obtain cooked rice in which the average major axis length was swollen to 9 mm. Then, the rice was steamed to obtain swollen cooked rice having a mass ratio of 320% with respect to the raw rice, followed by drying to thereby obtain dehydrated rice having the average major axis length of 8.7 mm and the extension rate of the major axis length of 184%. The rehydration properties of the dehydrated rice were evaluated by the similar method described above. The dehydrated rice 5 min after the hot water was poured was rehydrated and had an edible quality, but the stickiness of the rice before dehydration was high and workability was poor. Moreover, agglomeration of the rice grains after dehydration was excessive, and it was difficult to separate it into individual grains.

It is possible to obtain dehydrated rice in which the extension rate of the major axis length exceeds 160%, by immersing normal rice in hot water to become swollen and drying it by hot air. However, such a method requires excessive swelling of rice grains, resulting in reduction in the yield due to elution of the starch, roughness on the rice grain surface, degradation in taste, deterioration in workability due to stickiness, adhesiveness of the rice grains, deterioration in drying efficiency, etc. Therefore, it is preferable that the instant rice in which the extension rate of the major axis length is within the range of from 160% to 180% is produced by the production method according to the present embodiment.

### Comparative Example 31

Using “Onishi no Hakumai” by Onishi Foods Co., Ltd. and “Anshinmai” by Alpha Foods Co., Ltd. as instant rice (dehydrated alpharized rice) commercially available in Japan now, the average major axis lengths were measured. The value was approximately 153% to 156% with respect to 4.7 mm of the average major axis length of commercially-available polished rice.

For the instant rice, the rehydration properties were evaluated by the similar method described above. The dehydrated rice 5 min after the hot water was poured was not dehydrated, was hard, and was not edible.

The present invention is not limited to the above-mentioned embodiment, and can be variously modified in practical phase thereof within a range not departing from the scope of the invention. Furthermore, the above-mentioned embodiments may be combined, and in this case, combined effects are obtained. Moreover, the above-mentioned embodiments include various inventions, and various inventions can be extracted from appropriate combinations of a plurality of disclosed constituent features. For example, even if some of all the constituent features disclosed in the embodiments are deleted, in a case where the described problems can be solved and where the described effects can be obtained, the configuration in which some of all the constituent features are deleted can be extracted as an invention.

1. Instant rice, which is dehydrated alpharized rice, the instant rice having an average major axis length of from 160% to 180% of an average major axis length of raw rice of the instant rice.

2. A method of producing instant rice, the instant rice being dehydrated alpharized rice, the method comprising:
(a) obtaining water-absorbed rice, including boiling raw rice in hot water at a rice starch alpharization temperature or higher;
(b) obtaining steamed rice, including steaming the water-absorbed rice; and
(c) drying the steamed rice.

3. The method according to claim 2, wherein the instant rice has an average major axis length of from 160% to 180% of an average major axis length of the raw rice.

4. The method according to claim 2, wherein the obtaining (a) further comprises performing water cooling after boiling.

5. The method according to claim 2, wherein the obtaining (a) further comprises equalizing water contained in the water-absorbed rice after boiling or after water cooling if the obtaining (a) comprises performing water cooling after boiling.

6. The method according to claim 2, wherein the obtaining (a) further comprises draining water of the water-absorbed rice last.

7. The method according to claim 2, wherein the hot water at the rice starch alpharization temperature or higher used in the obtaining (a) is 90° C. or higher.

8. The method according to claim 2, wherein the water-absorbed rice obtained in the obtaining (a) is in a state in which starch on rice grain surface is alpharized and at least part of starch contained inside the rice grain is not alpharized.

9. The method according to claim 2, wherein the water-absorbed rice obtained in the obtaining (a) has a mass within a range of from 210% to 260% with respect to a mass of the raw rice.

10. The method according to claim 2, wherein the steamed rice obtained in the obtaining (b) has a mass within a range of from 210% to 270% with respect to a mass of the raw rice.

11. The method according to claim 2, further comprising immersing the raw rice in water before the obtaining (a).
